(19) United States
(12) Patent Application Publication
(10) Pub. No.: US 2007/0108728 A1
(43) Pub. Date: May 17, 2007

(54) Truck Bed Saver

(76) Inventors: James E. Germann, Raymond, IL (US); Marie Germann, Raymond, IL (US)

Correspondence Address: ADVANTIA LAW GROUP, 9035 SOUTH 1300 EAST, SUITE 200, SANDY, UT, 84094, US

(21) Appl. No.: 11/163,594

(22) Filed: Oct. 24, 2005

(51) Int. Cl. B62D 53/06

(52) U.S. Cl. 280/433

(57) ABSTRACT

A hitch safety device for preventing damage to a truck bed by a post. There is a hitch mount, a support plate and a funnel member. The hitch mount includes a first U-shaped member; and a first channel through the first U-shaped member. The support plate, disposed at least partially under the hitch mount, includes: a planar member; a first edge along the planar member, extending at least partially under the channel; and a second edge along the planar member, in a spaced relation to the first edge. The funnel member, coupled to the planar member at the second edge, includes: a second U-shaped member oriented substantially opposite the first U-shaped member; a holding member, coupled to the planar member at the second edge and configured to provide a bottom to the funnel member; and a second channel through the second U-shaped member and opening towards the support plate.

### BACKGROUND OF THE INVENTION

1. Field of the Invention

The present invention relates to hitch safety devices, specifically to hitch safety devices for preventing damage to a truck bed.

2. Description of the Related Art

In U.S. Pat. No. 6,491,317 to Breese et al. there is disclosed an attachment for a fifth wheel trailer hitch generally mounted within the bed of a vehicle to prevent damage to the vehicle in the event that the fifth wheel hitch fails due to faulty hook-up, the invention including a horizontal cross bar, two perpendicularly attached side bars with paired sets of bolt holes for mounting to the fifth wheel trailer hitch, a slide channel attached to the horizontal cross bar having an upper catch plate secured to the slide channel, and at least four bolts with lock nuts.

Further, in U.S. Pat. No. 5,013,060 to Van Andel et al. there is disclosed a bed saver device for protecting the bed and side rails of a truck or other towing vehicle against damage in the event that a towed vehicle-associated component of a fifth-wheel-type hitch comes free from the truck bed-mounted part of the hitch. The bed protecting device is mounted behind and immediately adjacent the truck-associated part of the hitch and includes a rectilinear plate, supported above the floor of the truck bed, which breaks the fall of the towed vehicle-associated component. Members incorporated in the bed saver and surrounding the restraining plate keep the towed vehicle-mounted component from sliding off the plate in event that the towed vehicle-associated hitch component comes loose from and drops onto the restraining plate.

What is needed is a hitch safety device that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available fifth wheel safety devices. Accordingly, the present invention has been developed to provide a hitch safety device for preventing damage to a truck bed by a post.

In one embodiment, there is a hitch safety device for preventing damage to a truck bed by a post. The hitch safety device may include a hitch mount a support plate, and/or a funnel member. The hitch mount may include a first U-shaped member; and a first channel through the first U-shaped member. The support plate may be disposed at least partially under the hitch mount. The support plate may include a planar member; a first edge along the planar member, extending at least partially under the channel; and/or a second edge along the planar member, in a spaced relation to the first edge. The funnel member may be coupled to the planar member at the second edge. The funnel member may include a second U-shaped member that may be oriented substantially opposite the first U-shaped member; a holding member, that may be coupled to the planar member at the second edge and may be configured to provide a bottom to the funnel member; and/or a second channel through the second U-shaped member and that may be opening towards the support plate.

The second U-shaped member may couple to the holding member at each of two side edges. The planar member may extend to and/or couple to each of two side members. The second U-shaped member may be smaller than the first U-shaped member and may be disposed vertically lower than the first U-shaped member.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a top perspective view of a hitch safety device according to one embodiment of the invention;

FIG. 2 illustrates a front perspective view of a hitch safety device according to one embodiment of the invention; and

FIG. 3 illustrates a side plan view of a hitch safety device according to one embodiment of the invention.

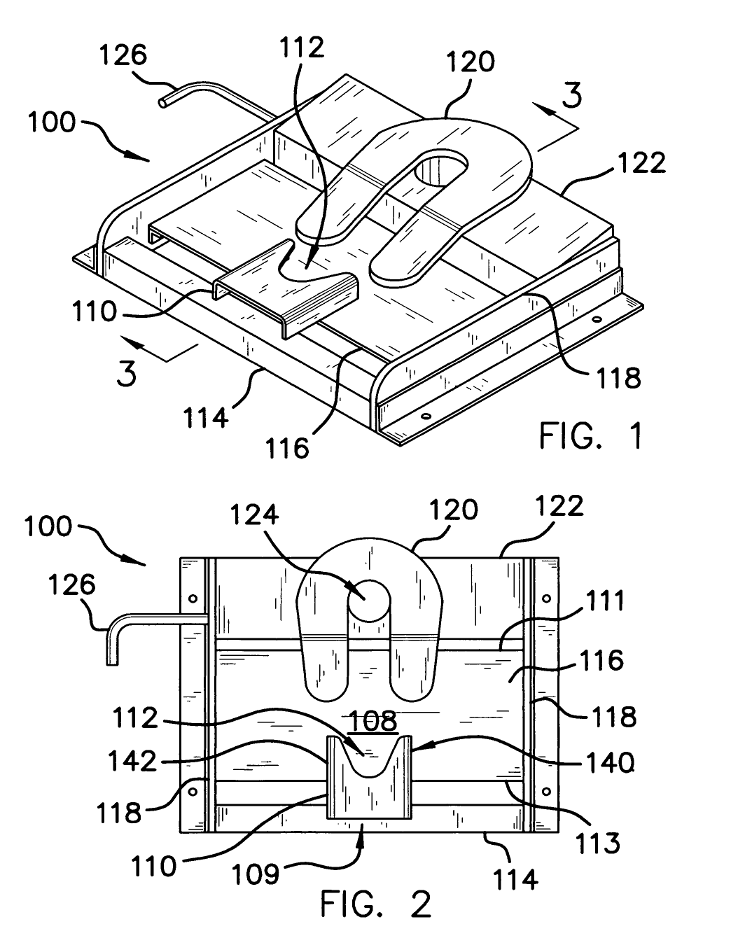

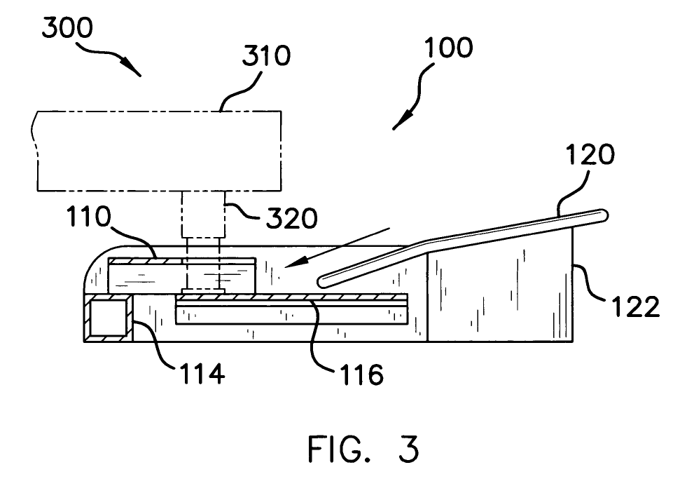

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Looking to the Figures, there is shown a hitch safety device 100 according to one embodiment of the invention. There is shown a hitch mount 120, a support plate 116, and a funnel member 109. The hitch mount 120 includes a first U-shaped member 120; and a first channel 124 through the first U-shaped member 120. The support plate 116, disposed at least partially under the hitch mount 120, includes: a planar member 116; a first edge 111 along the planar member 116, extending at least partially under the first channel 124; and a second edge 113 along the planar member 116, in a spaced relation to the first edge 111. The funnel member 109, coupled to the planar member 116 at the second edge 113, includes: a second U-shaped member 110 oriented substantially opposite the first U-shaped member 120; a holding member 108, coupled to the planar member 116 at the second edge 113 and configured to provide a bottom to the funnel member 109; and a second channel 112 through the second U-shaped member 110 and opening towards the support plate 116.

In the illustrated embodiment, the second U-shaped member 110 couples to the holding member 108 at each of two side edges 140 and 142. Also, the planar member 116 extends to and couples to each of two side members 118. Further, the second U-shaped member 110 is smaller than the first U-shaped member 120 and disposed vertically lower than the first U-shaped member 120. There is also shown a release handle 126 coupled to the hitch at a hitch plate 122 configured to support the first U-shaped member 120. There is shown a pair of support members 210 each coupled to a rear support 114. The support members 210 may be bolted to the hitch.

In operation, the hitch safety device 100 is configured to prevent a post 320 from coming in contact with a truck bed (not shown) by providing a supporting plate 116 under the first U-shaped member 120, such that a post 320 may not fall through the hitch safety device 100 and strike the truck bed, thereby causing damage thereto. As the post 320 must travel through the first channel 124 to be released from the first U-shaped member 120, subsequent to the post being supported by the support plate 116, the post will move towards the funnel shaped member 109 and be supported by the holding member 108 as it travels through the second channel 112 to be held by the second U-shaped member 110.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A hitch safety device for preventing damage to a truck bed, comprising:
a hitch mount, including:
a first U-shaped member; and
a first channel through the first U-shaped member;
a support plate disposed at least partially under the hitch mount, wherein the support plate includes:
a planar member;
a first edge along the planar member, extending at least partially under the first channel; and
a second edge along the planar member, in a spaced relation to the first edge; and
a funnel member coupled to the planar member at the second edge, the funnel member including:
a second U-shaped member oriented substantially opposite the first U-shaped member;
a holding member, coupled to the planar member at the second edge and configured to provide a bottom to the funnel member; and
a second channel through the second U-shaped member and opening towards the support plate.

2. The hitch safety device of claim 1, wherein the second U-shaped member couples to the holding member at each of two side edges.

3. The hitch safety device of claim 2, wherein the planar member extends to and couples to each of two side members.

4. The hitch safety device of claim 3, wherein the second U-shaped member is smaller than the first U-shaped member and disposed vertically lower than the first U-shaped member.

5. A hitch safety device for preventing damage to a truck bed, consisting essentially of:
a hitch mount, including:
a first U-shaped member; and
a first channel through the first U-shaped member;
a support plate disposed at least partially under the hitch mount, wherein the support plate includes:
a planar member;
a first edge along the planar member, extending at least partially under the first channel; and
a second edge along the planar member, in a spaced relation to the first edge; and
a funnel member coupled to the planar member at the second edge, the funnel member including:
a second U-shaped member oriented substantially opposite the first U-shaped member;
a holding member, coupled to the planar member at the second edge and configured to provide a bottom to the funnel member; and
a second channel through the second U-shaped member and opening towards the support plate.

6. The hitch safety device of claim 5, wherein the second U-shaped member couples to the holding member at each of two side edges.

7. The hitch safety device of claim 6, wherein the planar member extends to and couples to each of two side members.

8. The hitch safety device of claim 7, wherein the second U-shaped member is smaller than the first U-shaped member and disposed vertically lower than the first U-shaped member.
